(19) United States
(12) Patent Application Publication
(10) Pub. No.: US 2008/0020741 A1
(43) Pub. Date: Jan. 24, 2008

(54) Speed dial setting method in mobile communication terminal user interface and mobile communication terminal

(75) Inventor: Dong Chan Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/806,576

(22) Filed: Jun. 1, 2007

(30) Foreign Application Priority Data
Jul. 18, 2006 (JP) 2006-66726

(51) Int. Cl. H04B 1/38; H04M 3/42

(52) U.S. Cl. 455/415; 455/564

(57) ABSTRACT

A speed dial setting method in a mobile communication terminal user interface and a mobile communication terminal are provided. In a conventional speed dial setting method, a speed dial is set only through entering a speed dial setting menu, which is a sub menu of an address book, whereby there is a limitation in conveniently setting a speed dial by a user. The speed dial setting method in a mobile communication terminal user interface and a mobile communication terminal can set a speed dial by inputting a key for an extended period using a contact list or a recent communication list. Therefore, because a speed dial can be set in a contact list or a recent communication list that can include phone numbers stored in a mobile communication terminal, a user can conveniently set a speed dial without entering a speed dial setting menu.

### CROSS-REFERENCE TO RELATED APPLICATION

This application claims the benefit under 35 U.S.C. § 119(a) of a Korean Patent Application filed in The Korean Intellectual Property Office on Jul. 18, 2006 and assigned Serial No. 2006-66726, the entire disclosure of which is hereby incorporated by reference.

### BACKGROUND OF THE INVENTION

1. Field of the Invention

The present invention relates to a mobile communication terminal user interface and a mobile communication terminal. More particularly, the present invention relates to a speed dial setting method and a mobile communication terminal capable of setting a speed dial using a contact list (or a phonebook) or a recent communication list.

2. Description of the Related Art

A user interface of a mobile communication terminal such as a mobile phone is usually a screen displaying an interaction between a user and the terminal. User interfaces generally display various menus to be performed in the mobile communication terminal on a screen, and facilitate the user's ability to select the menus.

Conventional mobile communication terminals can be set to perform speed dialing by allocating a phone number to a specific key. The setting may also be performed in a speed dial setting menu.

FIG. 1 illustrates display screen images from a speed dial setting process in a user interface of a mobile communication terminal in the related art.

FIG. 1 refers to the speed dial setting method in the related art in which an address book 132 is selected among menus 131 displayed on a screen (FIG. 1a). Next, a speed dial 133 is selected among sub menus of the address book 132 (FIG. 1b). Next, a key 134 is selected among second to ninth keys displayed on the screen (FIG. 1c). A phone number of a contact ID 135 is selected (FIG. 1d) and stored (FIG. 1e) and a speed dial is set to a selected key 134 (FIG. 1f). FIG. 1 illustrates an example in which a speed dial is set to the second key 134.

Since the conventional speed dial setting method is performed only through entering a speed dial setting menu, a user's ability to conveniently set a speed dial is limited. That is, in the related art, phone numbers stored in a mobile communication terminal can be located and found in the contact list, but cannot be set to a speed dial through the contact list.

Accordingly, there is a need for an improved system and method for conveniently setting a speed dial by a user through a contact list.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a speed dial setting method in a mobile communication terminal user interface and a mobile communication terminal with which a speed dial can be conveniently set by a user without entering a speed dial setting menu.

Another object is to provide a speed dial setting method in a mobile communication terminal use interface and a mobile communication terminal with which a speed dial can be set corresponding to a phone number included in a contact list.

Another object is to provide a speed dial setting method in a mobile communication terminal user interface and a mobile communication terminal with which a speed dial can be set corresponding to a phone number included in a recent communication list.

In accordance with an aspect of an exemplary embodiment of the present invention, the above and other objects are accomplished by a speed dial setting method in a user interface of a mobile communication terminal that can set a speed dial by inputting a key for an extended period to select a phone number in a contact list or a recent communication list.

In accordance with an aspect of an exemplary embodiment of the present invention, the above and other objects are accomplished by a speed dial setting method in a user interface of a mobile communication terminal. A contact list in an address book and a contact ID in the contact list is selected and displayed. A key to be used for a speed dial corresponding to the contact ID is selected and a speed dial is set to the key by pressing the key for an extended period.

The contact ID may include at least one phone number.

The contact ID may include at least one selected from the group consisting of one terminal phone number, one home telephone number and one office telephone number.

Selecting and displaying a contact ID may include: displaying phone numbers of the contact ID; and selecting a phone number to set as a speed dial among the phone numbers.

If the phone numbers of the contact ID include a terminal phone number, the speed dial setting method may further include automatically selecting, the terminal phone number to a phone number to set as a speed dial.

Setting a speed dial to the key by pressing the key for an extended period may include pressing the key for an extended period, determining whether a speed dial has already been set to the key, and determining, if a speed dial has already been set to the key, whether to replace an existing phone number set as the speed dial with a phone number of a contact ID.

The speed dial setting method may further include setting, if a speed dial has not already been set to the key, a speed dial to the key.

The speed dial setting method may further include repeating the steps of the method from the step of selecting a key to be used for a speed dial corresponding to the contact ID if an existing phone number set as the speed dial is not to be replaced with a phone number of the contact ID.

The speed dial setting method may further include storing the speed dial set to the key in a memory unit.

In accordance with another aspect of an exemplary embodiment of the present invention, the above and other objects are accomplished by a speed dial setting method in a user interface of a mobile communication terminal including selecting an address book option among menus displayed in a screen and displaying the address book on the screen, selecting the contact list included in the address book and displaying the contact list on the screen, selecting a phone number of a contact ID included in the contact list and displaying the phone number of the contact ID on the screen, selecting a key to be used for a speed dial corresponding to the phone number, and setting a speed dial to the key by pressing the key for an extended period.

In accordance with another aspect of an exemplary embodiment of the present invention, the above and other objects are accomplished by a speed dial setting method in a user interface of a mobile communication terminal including. A recent communication list is displayed and a phone number in the recent communication list is selected. A key to be used for a speed dial corresponding to the phone number is selected and a speed dial is set to the key by pressing the key for an extended period.

In accordance with another aspect of an exemplary embodiment of the present invention, the above and other objects are accomplished by a mobile communication terminal that includes a key input unit for user input of selection information, a memory unit, a display unit and a controller. The memory unit stores a contact list and a recent communication list including phone numbers. The display unit displays an image according to the selection information of the key input unit and the controller extracts the contact list from the memory unit according to the selection information of the key input unit. The controller also displays the contact list in the display unit determines whether a key is input for an extended period corresponding to a phone number in the contact list through the key input unit, and controls the setting of a speed dial according to the determination.

The controller may display the recent communication list in the display unit according to the selection information of the key input unit, determines whether a key is input for an extended period corresponding to a phone number in the recent communication list through the key input unit, and controls the setting of a speed dial according to the determination.

The controller may include a long key determining unit and a speed dial setting unit. The long key determining unit determines whether a key for setting a speed dial is input for an extended period through the key input unit and the speed dial setting unit receives a long key signal from the long key determining unit and sets the corresponding phone number of the contact list or of the recent communication list to be dialed to correspond to a long key input to the key for a speed dial.

The speed dial setting unit may store the speed dial set to the key in the memory unit.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 illustrates the display of screen images from a speed dial setting process in a user interface of a mobile communication terminal in the related art;

FIG. 2 is a block diagram illustrating a configuration of a mobile communication terminal according to an exemplary embodiment of the present invention;

FIG. 3 is a flowchart illustrating a speed dial setting method in a user interface of a mobile communication terminal according to a first exemplary embodiment of the present invention;

FIGS. 4A and 4B illustrate display screen images from the speed dial setting method of FIG. 3; and

FIG. 5 is a flowchart illustrating a speed dial setting method in a user interface of a mobile communication terminal according to a second exemplary embodiment of the present invention.

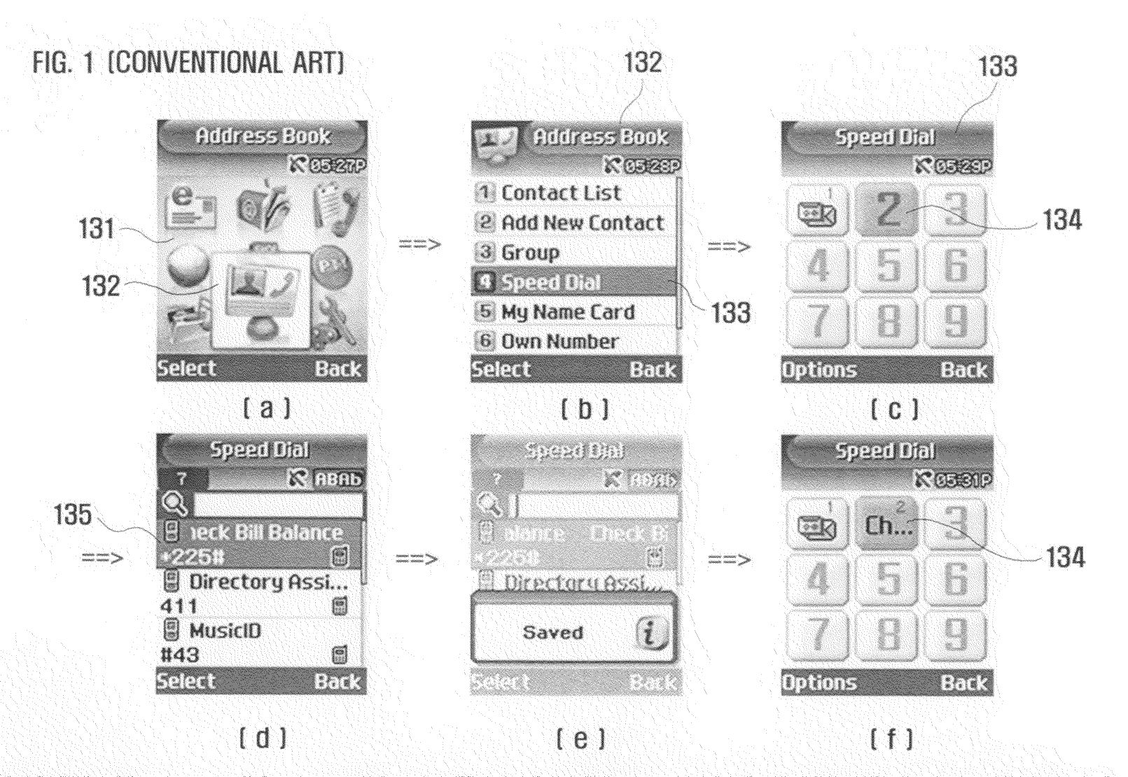

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An exemplary embodiment of the present invention is described in detail with reference to the attached drawings.

In the following description, a “long key” input is a method of inputting a user's selection information by pressing a key for a time period that is relatively longer than the typical amount of time it takes to press the key to effectuate corresponding input.

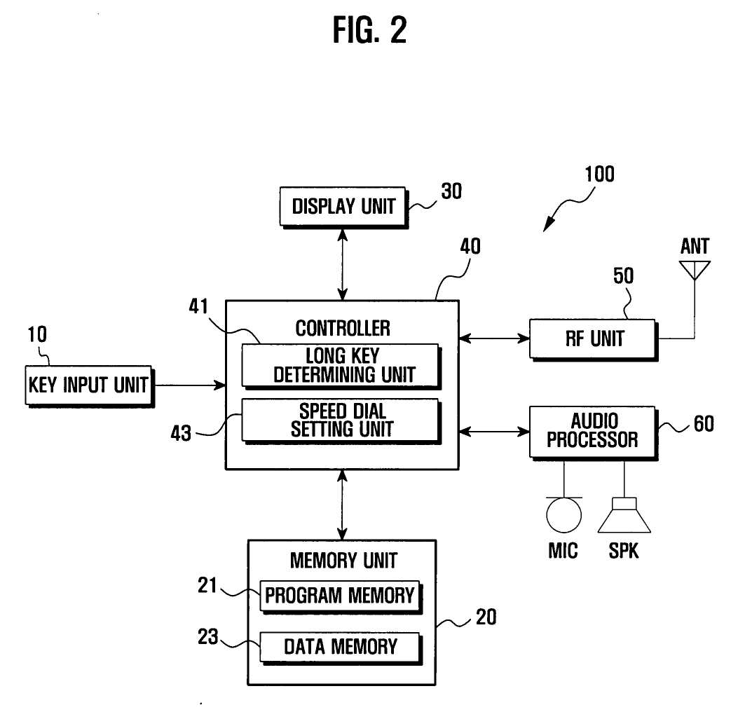

FIG. 2 is a block diagram illustrating a configuration of a mobile communication terminal 100 capable of setting a speed dial according to an exemplary embodiment of the present invention.

Referring to FIG. 2, the mobile communication terminal 100 includes a key input unit 10, a memory unit 20, a display unit 30, a controller 40, a radio frequency (RF) unit 50, and an audio processor 60.

The key input unit 10 provides a plurality of keys for user input to the mobile communication terminal 100 and transfers selection information according to the selection of a user to the controller 40.

The memory unit 20 includes a program memory 21 and a data memory 23. The program memory 21 stores program data necessary to control an operation of the mobile communication terminal 100. The data memory 23 stores data generated during the control by the controller 40 or during use by the user. According to an exemplary implementation, the data memory 23 includes a contact list and a recent communication list including phone numbers, and speed dial setting data.

The display unit 30 displays various function menus to be executed in the mobile communication terminal 100 and data stored in the memory unit 20 as an image on a screen. Particularly, the display unit 30 displays an image according to the key selection of the key input unit 10 and an image related to speed dial setting. The display unit 30 generally uses a liquid crystal display (LCD).

The controller 40 controls the entire operation of the units of the mobile communication terminal 100. The controller 40 determines whether a “long key” is input corresponding to a phone number in the contact list or the recent communication list through the key input unit 10 and controls the setting of a speed dial according to the determination.

The RF unit 50 performs modulation and frequency conversion of data output from the controller 40 and transmits an RF signal through an antenna (ANT). The RF unit 50 also separates a reception signal from other RF signals received through the antenna (ANT), performs frequency conversion and demodulation of the signal, and transmits the signal to the controller 40.

The audio processor 60 digitalizes a voice input to a microphone (MIC) through the control of the controller 40, performs demodulation of audio data received through the RF unit 50, and outputs the data through a speaker (SPK).

The controller 40 includes a long key determining unit 41 and a speed dial setting unit 43 for setting a speed dial.

The long key determining unit 41 determines whether a long key input through the key input unit 10 is a long key for setting a speed dial. According to an exemplary implementation, the long key determining unit 41 determines whether a key is a long key input corresponding to a phone number in a contact list.

When the speed dial setting unit 43 receives a long key signal from the long key determining unit 41, the speed dial setting unit 43 sets one of the phone numbers in a contact list or a recent communication list to be dialed as a speed dial to correspond to a long key input of the corresponding key for a speed dial and stores the speed dial set to the key in a data memory 23.

Therefore, because the mobile communication terminal 100 can set a speed dial corresponding to a phone number in a contact list or a recent communication list through inputting a long key, a user can conveniently set a speed dial without entering a speed dial setting menu.

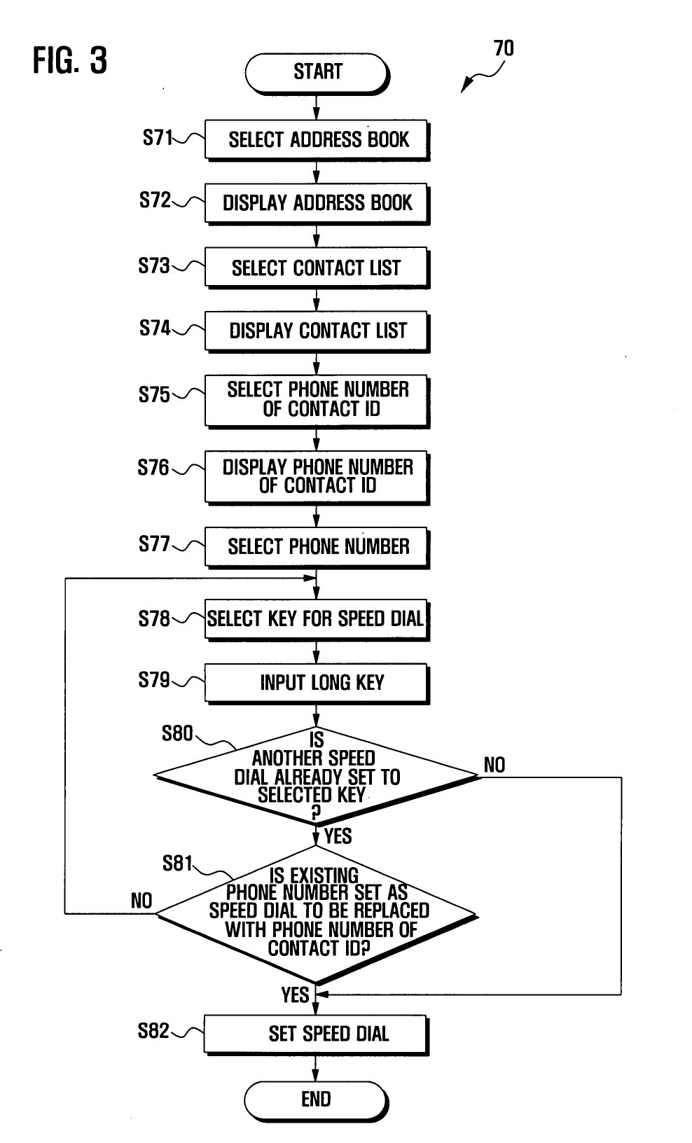

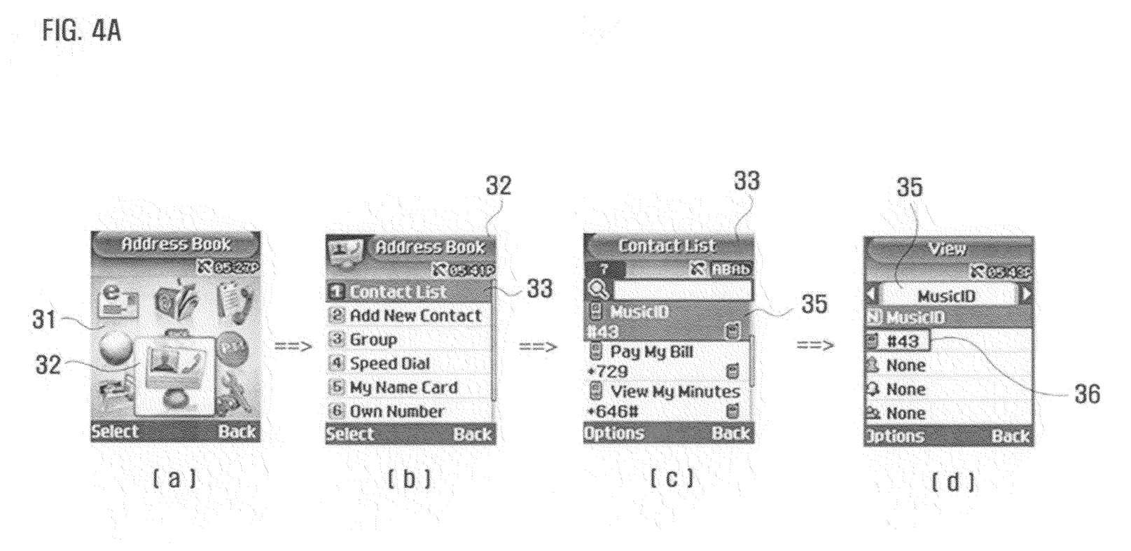

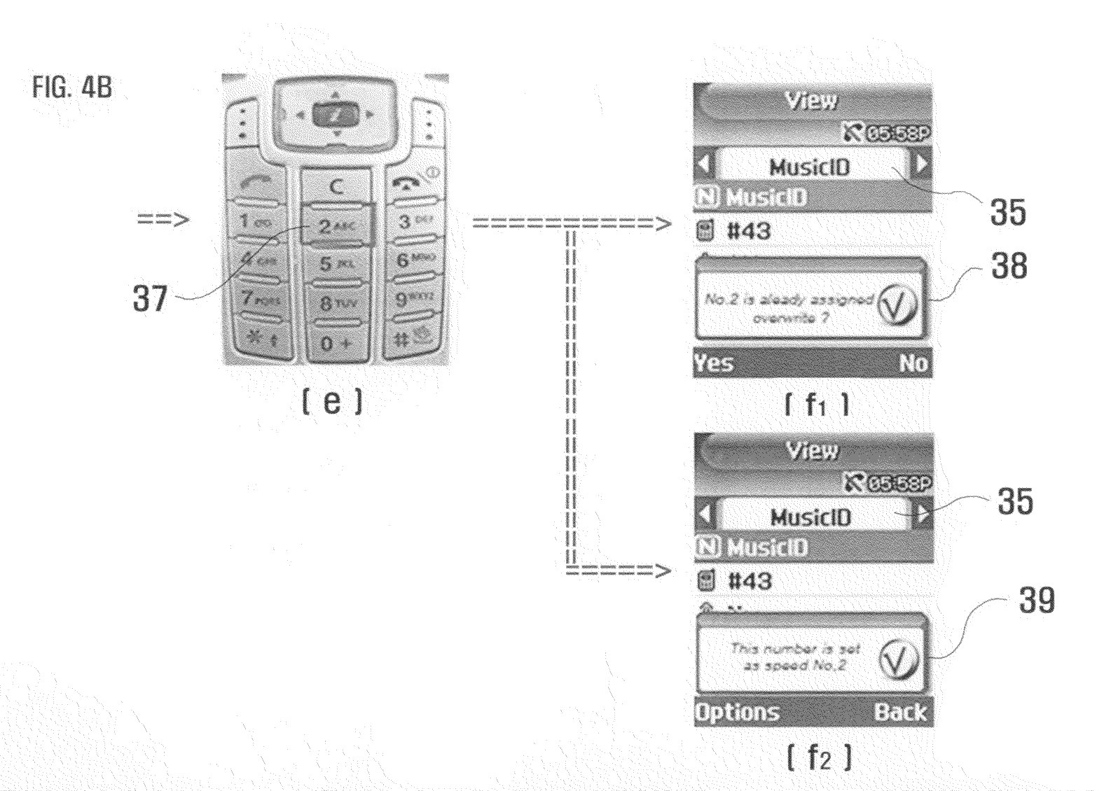

FIG. 3 is a flowchart illustrating a speed dial setting method 70 in a user interface of a mobile communication terminal according to a first exemplary embodiment of the present invention. FIGS. 4A and 4B illustrate display screen images from the speed dial setting method of FIG. 3.

Referring to FIGS. 3 and 4, the speed dial setting method 70 is sequentially described as follows.

The speed dial setting method 70, as illustrated in FIG. 4A(a), starts from a process of selecting an address book 32 option among menus 31 displayed on a screen of the display unit. The address book 32 is selected by a user (S71), and the controller displays the address book 32 on the screen (S72). The contact list including a phone number is stored in a data memory and speed dial setting data that has already been set may be included in the data memory.

Next, as illustrated in FIGS. 4A(b) and 4A(c), the user selects a contact list 33, which is a sub menu of the address book 32 (S73), and the controller extracts the contact list 33 in the data memory and displays the contact list 33 on the screen (S74).

As illustrated in FIG. 4A(d), the user then selects a contact ID 35 to set as a speed dial among contact IDs displayed in the contact list 33 (S75), and the controller displays phone numbers of the selected contact ID 35 on the screen (S76). The contact ID 35 can include at least one phone number. The contact ID may include at least one selected from the group consisting of one terminal phone number, one home telephone number, and one office telephone number.

According to an exemplary implementation, a phone number 36 to set as a speed dial is selected among the phone numbers of the contact ID 35 (S77). The phone number may be selected by the user 36 and may automatically be selected by the controller. In the latter case, when the contact ID 35 includes a terminal phone number, the controller selects the terminal phone number as a speed dial. For example, in FIG. 4A(d), “MusicID” may be selected as the contact ID 35 and a terminal phone number “#43” may be selected as a phone number 36.

According to an exemplary implementation, as illustrated in FIG. 4B(e), the user selects a key 37 for a speed dial (S78). For example, if a mobile communication terminal is a Global System for Mobile Communications (GSM) terminal, one of a “second” to “ninth” key can be selected as a key for a speed dial. FIG. 4B(e) illustrates an example in which a “second” key 37 is selected as a key for a speed dial. Two or more digit keys may also be selected as a key for a speed dial.

According to an exemplary implementation, when the user presses the selected key 37 for an extended period, such as, when the key is long key input (S79), the speed dial setting unit determines whether a speed dial has already been set to the selected key 37 (S80), If a speed dial has not already been set to the selected key 37, as illustrated in FIG. 4B(f2), the speed dial setting unit sets the corresponding key 37 to a key for a speed dial (S82). A window 39 for displaying that the selected key is set to the speed dial is displayed on a screen in which the contact ID 35 is displayed. If the user selects two digits of key, a final digit of key is input to a long key.

The long key determining unit determines whether the input key is a long key for setting a speed dial. The speed dial setting unit receives a long key signal from the long key determining unit and sets the corresponding key 37 to a key for a speed dial. The speed dial setting unit stores the set speed dial setting data in a data memory.

If a speed dial has already been set to the selected key 37 at step S80, as illustrated in FIG. 4B(f1), the speed dial setting unit displays a window 38 asking whether to replace the existing phone number set as the speed dial with the phone number 36 of the contact ID on a screen in which the contact ID 35 and the phone number 36 are displayed (S81). If the user decides to replace the existing phone number with the phone number 36 of the contact ID 35, the speed dial setting unit sets the selected key to a speed dial (S82). However, if the user does not decide to replace the existing phone number with the phone number of the contact ID, the controller displays processes on a screen so as to repeat the steps of the method from step S78 of selecting a key for a speed dial.

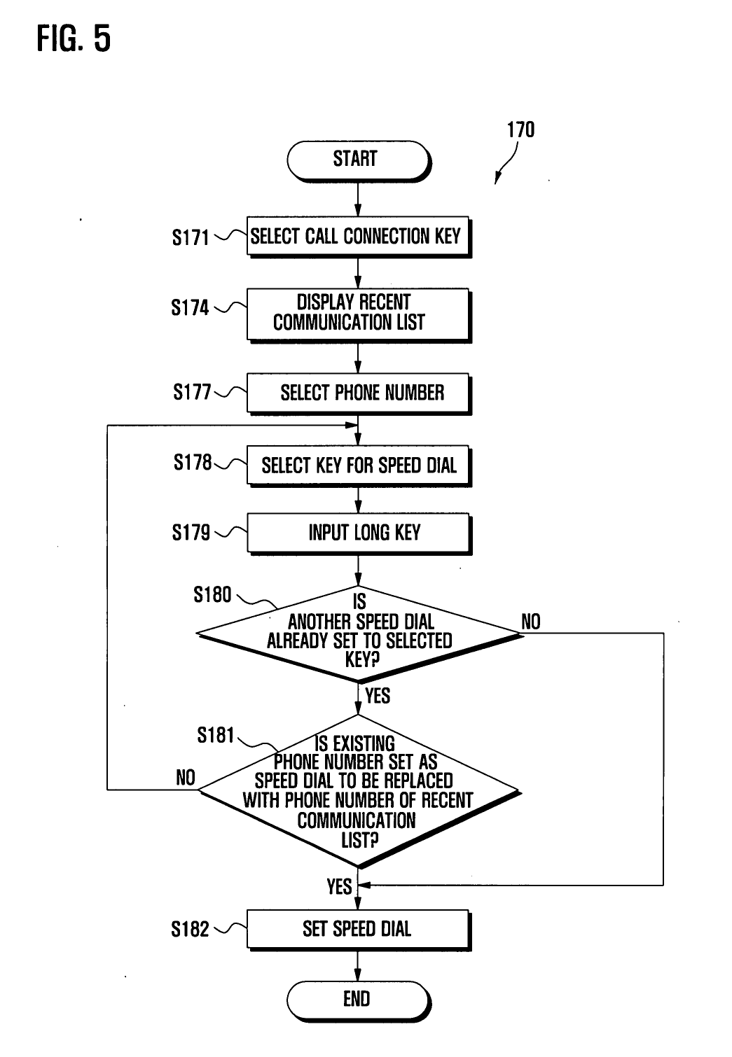

In the first exemplary embodiment of the present invention, a method of setting a speed dial corresponding to a phone number in a contact list of an address book is described. However, as illustrated in FIG. 5, a speed dial may be set to correspond to a phone number in a recent communication list.

FIG. 5 is a flowchart illustrating a speed dial setting method 170 in a user interface of a mobile communication terminal according to a second exemplary embodiment of the present invention.

Referring to FIG. 5, the speed dial setting method 170 is sequentially described as follows.

The speed dial setting method 170 starts from a process of selecting a call connection key (S171). That is, when the call connection key of a key input unit is selected by a user (S171), the controller displays a recent communication list on a screen (S174). The recent communication list includes phone numbers with which communication has been attempted, and a predetermined number of phone numbers are displayed on a screen in reverse time series backward from the most recent number.

According to an exemplary implementation, the user selects a phone number to set as a speed dial among the phone numbers displayed from the recent communication list (S177).

Subsequent steps (S178 to S182) are performed as in steps (S78 to S82) according to the first exemplary embodiment of the present invention and thus a speed dial can be set to correspond to a phone number selected from the recent communication list.

According to an exemplary embodiment of the present invention, because a speed dial can be set by inputting a key for an extended period to a phone number in a contact list or a recent communication list, a user can conveniently set a speed dial without entering a speed dial setting menu.

While the present invention has been shown and described with reference to certain exemplary embodiments thereof, by those skilled in the art that various changes in form and details may be made therein without departing from the spirit and scope of the invention as defined by the appended claims and their equivalents.

What is claimed is:

1. A speed dial setting method in a user interface of a mobile communication terminal, the method comprising:
selecting and displaying a contact list in an address book;
selecting and displaying a contact ID in the contact list;
selecting a key to be used for a speed dial corresponding to the contact ID; and
setting a speed dial to the key by pressing the key for an extended period.

2. The speed dial setting method of claim 1, wherein the contact ID comprises at least one phone number.

3. The speed dial setting method of claim 2, wherein the contact ID comprises at least one of a terminal phone number, home telephone number, and office telephone number.

4. The speed dial setting method of claim 3, wherein selecting and displaying a contact ID comprises:
displaying phone numbers of the contact ID; and
selecting a phone number to set as a speed dial among the phone numbers.

5. The speed dial setting method of claim 4, further comprising automatically selecting, if the phone numbers of the contact ID comprise a terminal phone number, the terminal phone number to set as a speed dial.

6. The speed dial setting method of claim 1, wherein setting a speed dial to the key by pressing the key for an extended period comprises:
pressing the key for an extended period;
determining whether a speed dial has already been set to the key; and
determining, if a speed dial has already been set to the key, whether to replace an existing phone number set as the speed dial with a phone number of the contact ID.

7. The speed dial setting method of claim 6, further comprising setting, if a speed dial has not already been set to the key, the speed dial to the key.

8. The speed dial setting method of claim 6, further comprising repeating the steps of the method from selecting of the key to be used for the speed dial corresponding to the contact ID if an existing phone number set as the speed dial is not to be replaced with a phone number of the contact ID.

9. The speed dial setting method of claim 1, further comprising storing the speed dial set to the key in a memory unit.

10. A speed dial setting method in a user interface of a mobile communication terminal, the method comprising:
selecting an address book option among menus displayed in a screen and displaying the address book on the screen;
selecting the contact list included in the address book and displaying the contact list on the screen;
selecting a phone number of a contact ID included in the contact list and displaying the phone number of the contact ID on the screen;
selecting a key to be used for a speed dial corresponding to the phone number; and
setting a speed dial to the key by pressing the key for an extended period.

11. The speed dial setting method of claim 10, wherein the selected phone number is at least one of a terminal phone number, home telephone number, and office telephone number.

12. The speed dial setting method of claim 11, further comprising automatically selecting, if the contact ID comprises a terminal number, the terminal phone number to a phone number to set as a speed dial.

13. The speed dial setting method of claim 10, wherein setting a speed dial to the key by pressing the key for an extended period comprises:
pressing the key for an extended period;
determining whether a speed dial has already been set to the key; and
determining, if a speed dial has already been set to the key, whether to replace an existing phone number set as the speed dial with the phone number of the contact ID.

14. A speed dial setting method in a user interface of a mobile communication terminal, the method comprising:
displaying a recent communication list;
selecting a phone number in the recent communication list;
selecting a key to be used for a speed dial corresponding to the phone number; and
setting a speed dial to the key by pressing the key for an extended period.

15. The speed dial setting method of claim 14, wherein setting a speed dial to the key by pressing the key for an extended period comprises:
pressing the key for an extended period;
determining whether a speed dial has already been set to the key; and
determining, if a speed dial has already been set to the key, whether to replace an existing phone number set as the speed dial with the phone number selected from the recent communication list.

16. The speed dial setting method of claim 15, further comprising setting, if a speed dial has not already been set to the key, a speed dial to the key.

17. A mobile communication terminal comprising:
a key input unit for input of selection information;
a memory unit for storing a contact list and a recent communication list comprising phone numbers;
a display unit for displaying an image according to the selection information of the key input unit; and
a controller for extracting the contact list from the memory unit according to the selection information of the key input unit and for displaying the contact list in the display unit, for determining whether a key is input for an extended period corresponds to a phone number in the contact list through the key input unit, and for controlling the setting of a speed dial according to the determination.

18. The mobile communication terminal of claim 17, wherein the controller displays the recent communication list in the display unit according to the selection information of the key input unit, determines whether a key is input for an extended period corresponding to a phone number in the recent communication list through the key input unit, and controls the setting of a speed dial according to the determination.

19. The mobile communication terminal of claim 18, wherein the controller comprises:
a long key determining unit for determining whether a key for setting a speed dial is input for an extended period through the key input unit; and
a speed dial setting unit for receiving a long key signal from the long key determining unit and setting the corresponding phone number of the contact list or of the recent communication list to be dialed to correspond to a long key input to the key for a speed dial.

20. The mobile communication terminal of claim 19, wherein the speed dial setting unit stores the speed dial set to the key in the memory unit.
